(19) United States
(12) Patent Application Publication
(10) Pub. No.: US 2013/0337550 A1
(43) Pub. Date: Dec. 19, 2013

(54) PROCESS FOR THE EXTRACTION OF LIPIDS

(71) Applicants: Karin Bus, Amsterdam (NL); Johannes Pieter Haan, Amsterdam (NL); Johannes Leendert Willem Cornelis Den Boestert, Amsterdam (NL); Jose Luis Bravo, Houston, TX (US)

(72) Inventors: Karin Bus, Amsterdam (NL); Johannes Pieter Haan, Amsterdam (NL); Johannes Leendert Willem Cornelis Den Boestert, Amsterdam (NL); Jose Luis Bravo, Houston, TX (US)

(21) Appl. No.: 13/995,200

(22) PCT Filed: Dec. 19, 2011
(86) PCT No.: PCT/EP11/73286

§ 371 Date: Sep. 4, 2013

Related U.S. Application Data
(60) Provisional application No. 61/424,843, filed on Dec. 20, 2010.

(51) Int. Cl. C11B 3/00

(52) U.S. Cl. CPC C11B 3/006; C11B 3/003
USPC 435/271; 554/206

(57) ABSTRACT

The present invention provides a process for the extraction of lipids from microbial lipid-containing feedstock, comprising the steps of (a) subjecting the microbial lipid-containing feedstock to a treatment to release the lipids thereby producing a mixture; (b) subjecting the mixture obtained in (a) to a filtration in the presence of a first extraction solvent on a filter, wherein organic matter soluble in an extraction solvent and an aqueous mixture are removed as filtrate from a retentate comprising non-soluble matter; (c) separating the filtrate obtained from the filter into an organic and aqueous phase; and (d) subjecting the organic phase to a distillation treatment to separate solvent and an organic residue comprising extracted lipids.

### FIELD OF THE INVENTION

The present invention relates to a process for the extraction of lipids from lipid-containing microbial biomass.

### BACKGROUND OF THE INVENTION

Microbial Lipids include monoglycerides, diglycerides and triglycerides that can be extracted from microbial biomass using processes known in the art, for example, drying, cell disruption, and solvent extraction. However, such lipids usually also obtain a large amount of phospholipids and glycolipids.

Aquatic biomass such as microalgae is a particularly interesting source of lipids that has been recommended for the production of fuels and chemicals. Microalgae have high growth rates, utilise a large fraction of solar energy and can grow in conditions that are not favourable for terrestrial biomass. Additionally, microalgae consume CO₂ at a high rate, and may reduce the carbon footprint of industrial processes such as for example, that produced in a cracking reaction into valuable biomass through photosynthesis, thereby converting atmospheric pollutants into valuable products.

Prior art processes focus on filtration, centrifugation and otherwise drying of lipophilic microbes to remove the growth medium, followed usually by a cell disruption step such as screw press treatments, cooking or other press filtrations that disrupt the cell walls. The thus treated microbial residues are then extracted, usually with a solvent that is capable of dissolving the lipids, but which is not soluble in water. This however involves the cumbersome handling of the sticky microbial residue, as well as the use of equipment capable of handling solid/liquid phase combinations. Examples for such processes are GB1466853 and U.S. Pat. No. 3958027.

### SUMMARY OF THE INVENTION

There is hence room for a process that does not involve handling of sludges and solids. Accordingly, in one embodiment a process for the extraction of lipids from microbial lipid-containing feedstock, comprising the steps of
(a) subjecting the microbial lipid-containing feedstock to a treatment to release the lipids thereby producing a mixture;
(b) subjecting the mixture obtained in (a) to a filtration in the presence of a first extraction solvent on a filter, wherein organic matter soluble in an extraction solvent and an aqueous mixture are removed as filtrate from a retentate comprising non-soluble matter;
(c) separating the filtrate obtained from the filter into an organic and aqueous phase; and
(d) subjecting the organic phase to a distillation treatment to separate solvent and an organic residue comprising extracted lipids.

### DESCRIPTION OF THE FIGURES

FIG. 1 is a black flow diagram illustrating an embodiment of production pathway associated with the present invention.

FIG. 2 illustrates a process line-up for the extraction of lipids using a single extraction solvent.

FIG. 3 illustrates a process line-up for the extraction of lipids using a two extraction solvents.

### DETAILED DESCRIPTION OF THE INVENTION

It has now been found that the extraction of lipids from microbial feedstocks can advantageously be integrated with a process to release lipids from microbial cells.

Lipophilic microbes, including microalgae, bacteria and/or yeasts as referred to in the present invention are a large and diverse group of microorganisms that can be unicellular or multicellular. The microbes can be cultivated under difficult agro-climatic conditions, including cultivation in freshwater, saline water, moist earth, dry sand and other open-culture conditions known in the art. The microbes can also be cultivated and genetically engineered in controlled closed-culture systems, for example, in closed bioreactors. Preferably, microbes used in the present invention are marine microalgae cultivated in fresh water, saline water or other moist conditions, more preferably marine microalgae cultivated in saline water. Yet more preferably, the marine microalgae are cultivated in open-culture conditions, for example, in open ponds. These marine microalgae can include members from various divisions of algae, including diatoms, pyrrophyta, ochrophyta, chlorophyta, euglenophyta, dinoflagellata, chrysophyta, phaeophyta, rhodophyta. A further group of marine microbes according to the invention Cyanobacteria, which are included in the definition of microalgae in the present specification. Preferably, the marine microalgae are members from the diatoms or ochrophyta division, more preferably from the raphid, araphid, and centric diatom family.

Lipids as referred to in the present invention are a group of naturally occurring compounds that are usually hydrophobic in nature and contain long-chain aliphatic hydrocarbons and their derivatives such as fatty acids, alcohols, amines, amino alcohols and aldehydes. The lipid-containing feedstock as disclosed in the invention includes lipids derived from marine microalgae, yeasts, and bacteria. These lipids include monoglycerides, diglycerides and triglycerides, which are esters of glycerol and fatty acids, and phospholipids, which are esters of glycerol and phosphate group-substituted fatty acids.

The fatty acid moiety in the lipids used in the invention preferably ranges from 4 carbon atoms to 30 carbon atoms, and preferably includes saturated fatty acids containing one, two or three double bonds. Preferably, the fatty acid moiety includes 8 carbon atoms to 26 carbon atoms, more preferably the fatty acid moiety includes 10 carbon atoms to 25 carbon atoms, again more preferably the fatty acid moiety includes 12 carbon atoms to 23 carbon atoms, and yet more preferably 14 carbon atoms to 20 carbon atoms. The lipids may contain variable amounts of free fatty acids and/or esters, both of which may also be converted into hydrocarbons during the process of this invention. The lipids may be composed of natural glycerides only. Alternatively, the lipids may also include carotenoids, hydrocarbons, phosphatides, simple fatty acids and their esters, terpenes, sterols, fatty alcohols, tocopherols, polyisoprene, carbohydrates and proteins. It is to be understood that for the purpose of this invention, a mixture of lipids extracted from different microalgae sources can also be used as the lipid-containing feedstock.

Preferably, the lipid-containing feedstock includes lipids in the range of 1 wt % to 50 wt %, more preferably in the range of 2 wt % to 40 wt %, more preferably in the range of 3 wt % to 30 wt %, and yet more preferably in the range of 5 wt % to 20 wt %.

Step (a) of the subject process preferably involves subjecting the microbial lipid-containing feedstock to a cell disruption treatment or lipids releasing treatment. Any suitable treatment that disrupts the cell walls, inverts the cells or otherwise makes the lipids in the cell accessible to medium surrounding the microbial cells may be employed.

Preferably, a biochemical treatment is used, such as viral or enzymatic cell wall destruction; and/or a thermal treatment, such as steam heating or microwave heating; and/or a (thermo)chemical treatment with chemical compounds such as for instance alkaline solutions; and/or a physical treatment, such as pressure drop or a high shear treatment, preferably a ball mill treatment, an extrusion treatment, or combinations of the above treatments.

The slurry comprising the lipophilic microbes may also be preferably pumped through thin silicon carbide (“SiC”) channels (0.3-3 m length) with a high surface roughness. Linear velocities of the slurry should be in the order of 1-5 m/s, which causes a turbulent flow (large shear forces).

Since SiC is an abrasive and attrition resistant material, which can be produced with a high surface roughness, this will promote the disruption of microbial cells, comparable to the action of a course sandpaper on the human skin. This will advantageously require lower pressure to achieve cell disruption, as compared to French press or similar treatments. Alternatively to the use of thin SiC channels, the microbial feedstock may also be pumped through a micro-porous SiC matrix. Preferably, the thickness of the matrix is most likely in the range of a few centimetres. Preferably the porosity of the matrix will be approximately 30-40%.

The slurry comprising the lipophilic microbes, preferably having a dry matter content of between 5 to 20% wt. content, is advantageously fed between two counter rotating cylinders. The cylinders may be placed very close to each other; preferably having a very small gap of less than 2 micrometers. This will advantageously press the cells and squeeze cell contents out. The counter rotating cylinders preferably are made of a porous abrasive resistant material, such as silicon carbide. The pore size of the rotating cylinders preferably is in the range of from 0.01 to 0.1 micrometers. Inside the rotating cylinders, a slight vacuum may be applied. This pressure difference will preferably transport the squeezed liquid originating from the cells inside the cylinders to where it is collected for further processing. Preferably, by selecting a hydrophilic or organophilic ceramic material for the cylinders, a preferential removal water or oily matter can be achieved, applying two or more process steps, e.g. in a first step, hydrophilic cylinders could be chosen to remove the bulk of the water, whilst thereafter oligophilic cylinders mainly remove the oily matter. To enhance the whole process the cylinders preferably may be heated at a range of from 50 to 85° C. to lower the viscosity of the squeezed liquid, hence facilitating the transport through the porous wall of the rotating cylinders. The material not transported through the porous pressing cylinders will be mainly comprised of a solid with some residual water and oil. This material, protein rich, may preferably be dried for storage and transport, for use as fish or animal feed.

Preferably, the microbial lipid-containing feedstock is subjected to a centrifugation prior to step (a) to a dry matter content of from 20 to 25% wt. prior to step (a) to avoid having to remove larger amounts of water after step (a). Preferably the mixture obtained in step (a) is subjected to a mechanical de-watering treatment, preferably centrifugation, to a dry matter content of from 25-50% wt. Again, this will further reduce the amount of water that needs to be removed in the process.

Applicants have found that in particular diatomic algae are difficult to disrupt since they have strong cell walls formed mainly from silica crystals.

In step (b), the mixture obtained in (a) is subjected to a filtration in the presence of a first extraction solvent on a, preferably wash, filter, wherein organic matter soluble in an extraction solvent is removed as filtrate from a retentate comprising non-soluble matter.

In a preferred embodiment of the subject process, the harvested microbial feedstock, preferably microalgae, are first dewatered by centrifugation to about 10-15% wt. dry matter, and subsequently be submitted to a cell disruption step (a) to release both lipids and internal cell water. Subsequently, the obtained mixture may advantageously be further mechanically de-watered, e.g. by a second centrifugation. This will result in a much dryer product cake, having from 25, preferably 40 to 50% wt. dry matter. Hence much less water needs to be evaporated in a dryer, while also back-blending of dry material with feed slurry may be avoided, as required by most drier operating regimes require a narrow feed consistency.

Preferably, the subject process further comprises subjecting the aqueous phase obtained in (c) to a counter current extraction with a second extraction solvent to recover remaining organic material from the aqueous stream. More preferably, the obtained water stream may be sent to a bio-treater to allow the removal of any remaining solvents before discharging as cleaned process water. Alternatively, the water may preferably be recycled to the microbial lipid-containing feedstock growing system, such as algae farms or fermentor and bioreactors.

In a preferred embodiment, the first and the second extraction solvent have a different polarity. Although this may require a separate distillation column, the benefit is due to the fact that the extraction/washing of the extracted lipids will occur from different matrices. This optional embodiment of the present invention may advantageously be used for optimisation in the process of recovering lipids.

Each solvent molecule is usually described by three Hansen Solubility Parameters, expressed in MPa^{0.5}. These are: δd for the energy from dispersion bonds between molecules; δp for the energy from polar bonds between molecules and δh for the energy from hydrogen bonds between molecules.

If the process according to the subject invention is performed with a single extraction solvent, as first and/or second solvent, the solvent Hansen solubility parameters of the solvent preferably are 14.5<δd<16; 0<δp<4.5; and 0<δh<5. Preferred extractant solvents may be single solvents or blends, preferably heptane and heptane/isopropanol blends.

If the process is performed with a first and second solvent that are different from each other, the Hansen solubility parameters of the first solvent preferably are:
δd of from 14.5 to 16;
δp of from 0 to 4.5; and
δh of from 0 to 5.

Preferably, the Hansen solubility parameters of the second solvent are:
δd of from 14.5 to 16;
δp of from 2.5 to 14.5; and
δh of from 2.5 to 16.

In step (d), the organic phase is subjected to a distillation treatment to separate solvent and an organic residue comprising extracted lipids. Any suitable distillation step known to a skilled person may be applied. Preferably solar energy is used for this step, in order to render the process even more sustainable. Conveniently separated solvent may be recycled to step (b) and optionally also to step (a) and/or (c).

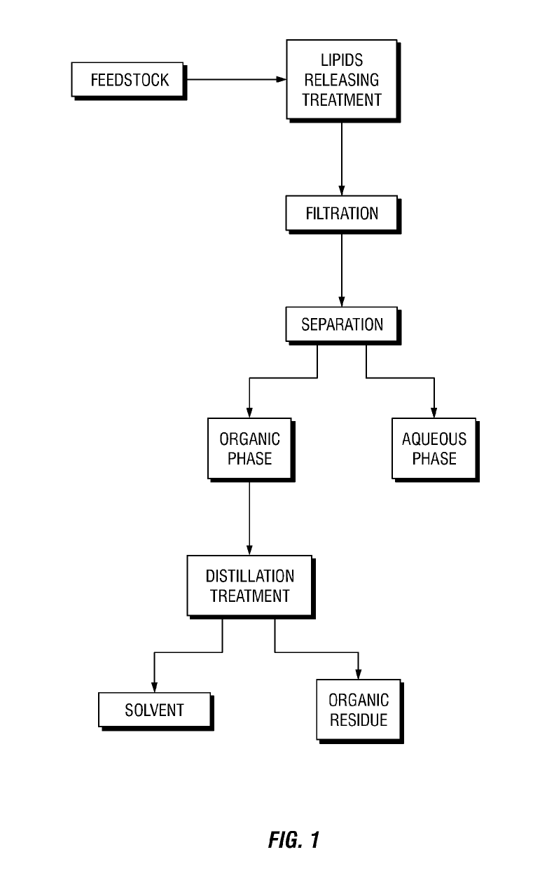

FIG. 1 discloses a black flow diagram illustrating an embodiment of the production pathway associated with the present invention. It shows how a microbial lipid containing feedstock is first submitted to a lipids releasing treatment, whereafter the mixture produced by this lipids releasing treatment is submitted to a filtration as described above for step (b). Hereafter the filtrate submitted to a separation providing an organic phase and an aqueous phase. The organic phase is subsequently forwarded to a distillation treatment to provide a solvent and an organic residue.

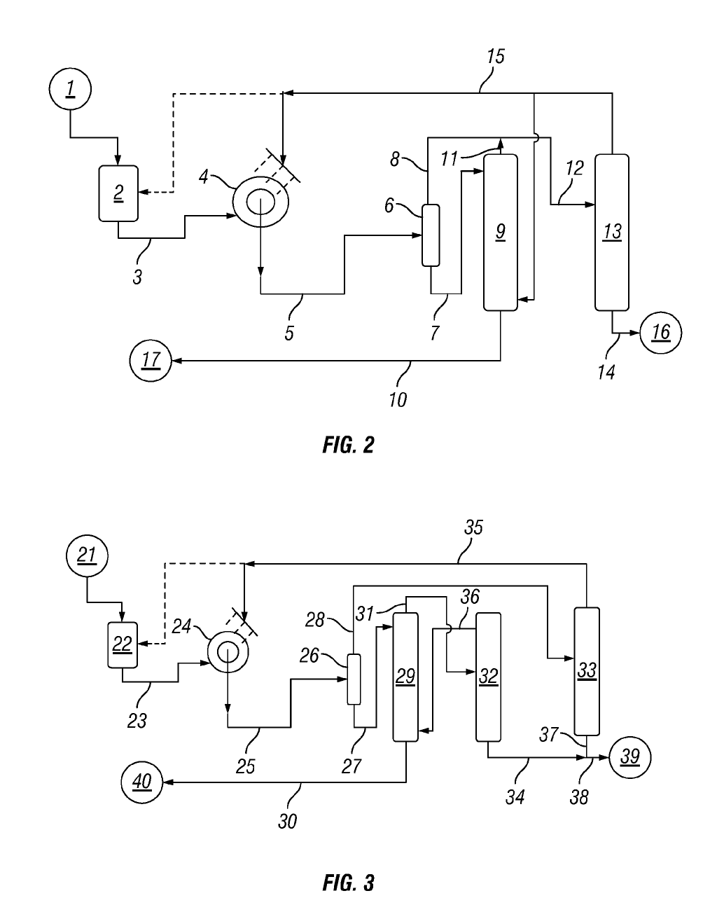

FIG. 2 illustrates one embodiment of a process line-up for the extraction of lipids using a single extraction solvent: Lipid-containing microbial sludge (thickened cell matter) 1 enters a first reactor 2 (cell disrupter or lipids release), wherein the lipids are released to produce a mixture 3. The mixture that is obtained is then sent through a line to a wash filter 4, wherein extraction solvent 15 is added. Additional solvent may be supplied to the first lipids release reactor 2. The filtrate 5 obtained in the wash filter is then sent to a phase separator 6, and the solvent stream 8, here a top stream if the organic phase comprising the solvent is lighter than water, sent via line 12 to a vacuum stripper 13 to remove solvent 15 from the organic residue 14 that contains extracted lipids 16. The top stream comprising recovered solvent 15 is sent back to the extractor unit 9, the wash filter 4 and/or the lipid release reactor 2. The bottom stream 7 of the phase separator 6 is sent to an extractor 9, to remove additional lipids 11 by additional solvent 15 from an aqueous waste stream 10, which is sent out of the process as sweet or salt water 17. Solvent may also be added to the extraction unit 9, while any solvent recovered 11 from the extractor 9 is also sent via line 12 to the vacuum stripper 13.

FIG. 3 illustrates another embodiment of a process line-up for the extraction of lipids using a two extraction solvents: Lipid-containing microbial sludge (thickened cell matter) 21 enters a first reactor 22 (cell disruptor or lipids release), wherein the lipids are released to produce a mixture 23. The mixture that is obtained is then sent through a line to a wash filter 24, wherein a first extraction solvent 35 is added. Additional first solvent may be supplied to the first lipids release reactor 22. The filtrate 25 obtained in the wash filter is then sent to a phase separator 26, wherein it is separated into an aqueous phase 27 and an organic phase 28. The organic phase 28 is passed on as a top stream (if the organic phase comprising the solvent is lighter than water, otherwise the bottom stream), and is sent to a first vacuum stripper 33 to remove solvent 35 from the organic residue 38 that contains extracted lipids 39.

The (aqueous) bottom stream 27 is sent to an extractor 29, where the stream is extracted by a second extraction solvent 36. The top stream 31, containing extracted lipids and the second solvent are sent to a second vacuum stripper 32. The second solvent 36 may be added to the second vacuum stripper (not shown). The bottom (waste) stream 30 of the extractor is sent out of the process as sweet or salt water 40. The top stream 36 of the second vacuum stripper comprising recovered second solvent is sent back to the extractor unit 29, while the bottom stream 34 comprising residual lipids is combined with the bottom stream 37 of the first vacuum stripper 33 to form a combined stream 38 containing lipids 39.

1. A process for the extraction of lipids from microbial lipid-containing feedstock, comprising the steps of
(a) subjecting the microbial lipid-containing feedstock to a treatment to release at least a portion of the lipids thereby producing a mixture;
(b) subjecting the mixture obtained in (a) to a filtration in the presence of a first extraction solvent on a filter, wherein an organic matter soluble in an extraction solvent and an aqueous mixture are removed as filtrate from a retentate comprising non-soluble matter;
(c) separating the filtrate obtained from the filter into an phase and an aqueous phase; and
(d) subjecting at least a portion of the organic phase to a distillation treatment to separate a solvent and an organic residue comprising an extracted lipid.

2. The process of claim 1, wherein the microbial lipid-containing feedstock is subjected to a centrifugation prior to step (a) to a dry matter content of from 20 to 25% wt.

3. The process of claim 1, further comprising subjecting the mixture obtained in step (a) to a mechanical de-watering treatment to a dry matter content of from 25-50% wt.

4. The process of claim 1, wherein the treatment of step (a) comprises a cell disruption treatment.

5. The process of claim 4, wherein step (a) comprises at least one of a biochemical treatment, a thermal treatment, a (thermo)chemical treatment, and a physical treatment suitable to disrupt the cell wall.

6. The process of claim 1, further comprising subjecting at least a portion of the aqueous phase obtained in (c) to a counter current extraction with a second extraction solvent to recover at least a portion of the remaining organic material from the aqueous phase.

7. The process of claim 6, further comprising sending the at least a portion of the aqueous phase to a bio-treater.

8. The process of according to claim 1, wherein the solvent Hansen solubility parameters are 14.5<δd<16; 0<δp<4.5; and 0<δh<5.

9. The process of claim 6, wherein the first and the second extraction solvent have a different polarity.

10. The process of claim 6, wherein the Hansen solubility parameters of the first solvent are 14.5<δd<16; 0<δp<2.5; and 0<δh<2.5; and wherein the Hansen solubility parameters of the second solvent are 14.5<δd<16; 2.5<δp<14.5 and 2.5<δh<16.

11. The process of claim 1, wherein the microbial biomass comprises a marine microalgae.

12. The process of claim 1, wherein the microbial lipid-containing feedstock comprises from 2 wt % to 30 wt % lipids.

13. The process of claim 3, wherein the mechanical de-watering treatment comprises centrifugation.

14. The process of claim 1, wherein the treatment of step (a) comprises a treatment where at least a portion of the lipids are released while keeping the cell structure intact.

15. The process of claim 5 wherein the biochemical treatment comprises contacting the microbial lipid-containing feed stock with at least one of a virus and an enzyme and under at least one condition suitable to disrupt a cell wall.

16. The process of claim 5 wherein the thermal treatment comprises at least one of a steam treating and a microwave heating.

17. The process of claim 5 wherein the (thermo)chemical treatment comprises contacting the microbial lipid-containing feedstock with one or more chemical solutions.

19. The process of claim 5 wherein the physical treatment comprises at least one of a pressure drop treatment, a high shear treatment, a ball mill treatment, and an extrusion treatment.

20. The process of claim 6 further comprising recycling at least a portion of the aqueous phase to a system growing the microbial lipid-containing feedstock.

21. The process of claim 11 wherein the marine microalgae comprises a diatomic microalgae.

22. The process of claim 12 wherein the microbial lipid-containing feedstock comprises 5 wt % to 20 wt % lipids.
